(19) United States
(12) Patent Application Publication
(10) Pub. No.: US 2004/0211066 A1
(43) Pub. Date: Oct. 28, 2004

(54) Cracker for rigid-shelled food

(76) Inventor: Ruey-Lan Horng, Yung-Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/419,835

(22) Filed: Apr. 22, 2003

(51) Int. Cl. B26B 17/00; A47J 43/26

(52) U.S. Cl. 30/120.3; 30/120.2

(57) ABSTRACT

A cracker comprises a first handle and a second handle including an end pivotally connected to an end of the first handle. The first handle further includes a first working face and a second working face on two opposite sides thereof The second handle includes a first working face and a second working face on two opposite sides thereof The first working faces of the first handle and the second handle together define a first crushing space when the first handle and the second handle are in a first relative position. The second working faces of the first handle and the second handle together define a second crushing space when the first handle and the second handle are in a second relative position.

### BACKGROUND OF THE INVENTION

1. Field of the Invention

The present invention relates to a cracker for rigid-shelled food and, more particularly to a cracker that can be used to crack more than one kind of rigid-shelled food, such as walnuts, crab claws, etc.

2. Description of the Related Art

FIG. 1 of the drawings illustrates a conventional cracker 1 comprising a pair of handles 11 that are pivotally connected at 12. The handles 11 include two opposed concave working faces 111 between which a crushing space 112 is defined, each working face 111 including a plurality of catching ribs 113 for reliably catching rigid-shelled food (such as a walnut) held in the crushing space 112. A user may apply a force to urge the handles 11 toward each other and thus crush a rigid shell of food received in the crushing space 112. However, the shapes and sizes of rigid-shelled food vary a lot. The crushing space 112 may just be suitable for a certain kind of rigid-shelled food, such as walnut or crab claws. As a result, more than one cracker must be prepared when there are several kinds of rigid-shelled food, which results in an increase in the cost and the storage space.

### SUMMARY OF THE INVENTION

An object of the present invention is to provide an improved cracker for rigid-shelled food of different kinds.

A cracker in accordance with the present invention comprises a first handle including a first end and a second end and a second handle including an end pivotally connected to the first end of the first handle. The first handle further includes a first working face on a first side thereof and a second working face on a second side thereof that is opposite to the first side of the first handle. The second handle includes a first working face on a first side thereof and a second working face on a second side thereof that is opposite to the first side of the second handle.

The first working face of the first handle and the first working face of the second handle together define a first crushing space when the first handle and the second handle are in a first relative position. The second working face of the first handle and the second working face of the second handle together define a second crushing space when the first handle and the second handle are in a second relative position.

The first crushing space is capable of receiving a rigid-shelled food of a first kind. The second crushing space is capable of receiving a rigid-shelled food of a second kind other than the rigid-shelled food of the first kind. The first working face of each of the first handle and the second handle comprises a plurality of catching ribs for catching the rigid-shelled food of the first kind received in the first crushing space. The second working face of each of the first handle and the second handle comprises a plurality of catching ribs for catching the rigid-shelled food of the second kind received in the second crushing space.

The first end of the first handle and the end of the second handle are pivoted together by a pin. A resilient member is mounted around the pin and includes a first end attached to the first end of the handle and a second end attached to the end of the second handle. The resilient member returns the first handle and the second handle to their original position when a force applied to the first handle and the second handle is released.

The first working face of the first handle is formed on a section of the first side of the first handle adjacent to the first end of the first handle. The first working face of the second handle is formed on a section of the first side of the second handle adjacent to the end of the second handle. The second working face of the first handle is formed on an intermediate section of the second side of the first handle. The second working face of the second handle is formed on an intermediate section of the second side of the second handle.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a conventional cracker.

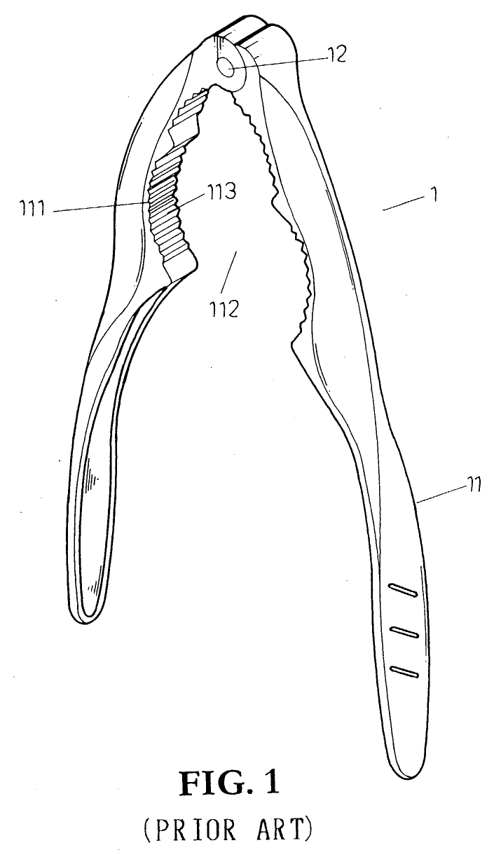

FIG. 2 is a perspective view of a cracker in accordance with the present invention.

FIG. 3 is a perspective view illustrating use of the cracker in accordance with the present invention for crushing a crab claw.

FIG. 4 is a perspective view illustrating use of the cracker in accordance with the present invention for crushing a walnut.

FIG. 5 is a perspective view illustrating use of the cracker in accordance with the present invention as a bottle opener.

FIG. 6 is an exploded perspective view of the cracker in accordance with the present invention.

### DETAILED DESCRIPTION OF THE PREFERRED EMBODIMENT

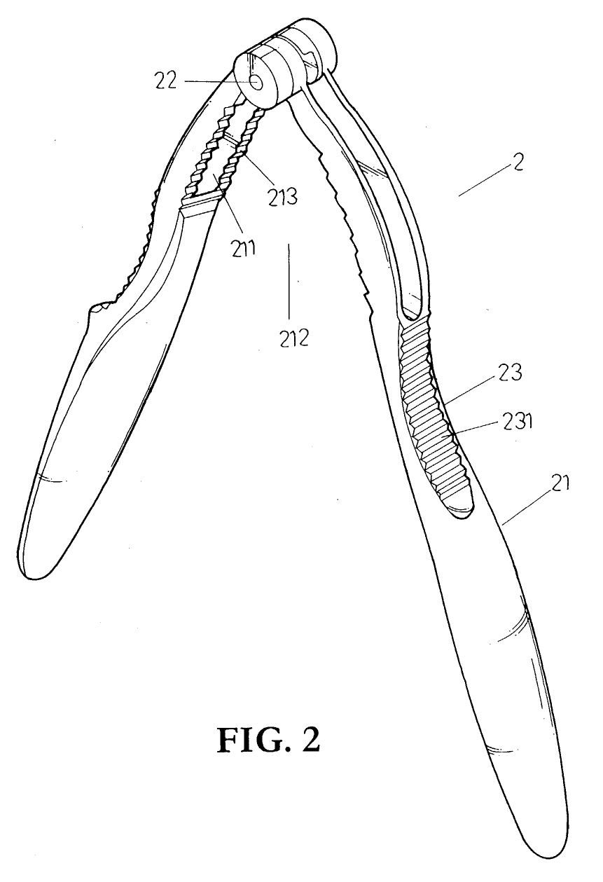

Referring to FIG. 2, a cracker for rigid-shelled food in accordance with the present invention generally includes two handles 21 that are pivotally connected by a pin 22 at one of two ends thereof. Each handle 21 includes a first side having a first working face 211 formed on an upper section thereof adjacent to the pivot 22. The first working face 211 includes a plurality of catching teeth or ribs 213 formed thereon. Each handle 21 further includes a second side having a second working face 23 formed on an intermediate section thereof. The second working face 23 includes a plurality of catching teeth or ribs 231 formed thereon. A user may apply force to non-pivoted ends of the handles 21 to crush rigid-shelled food.

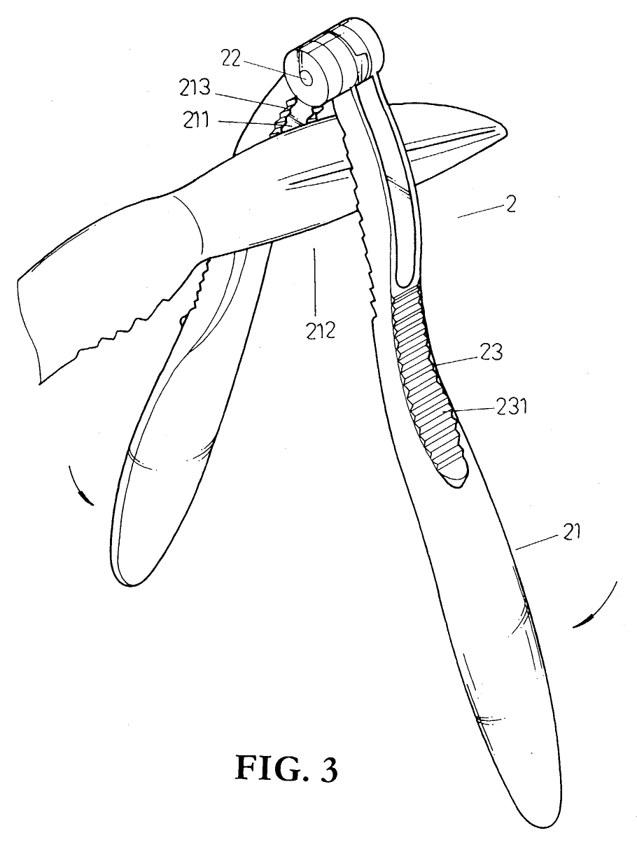

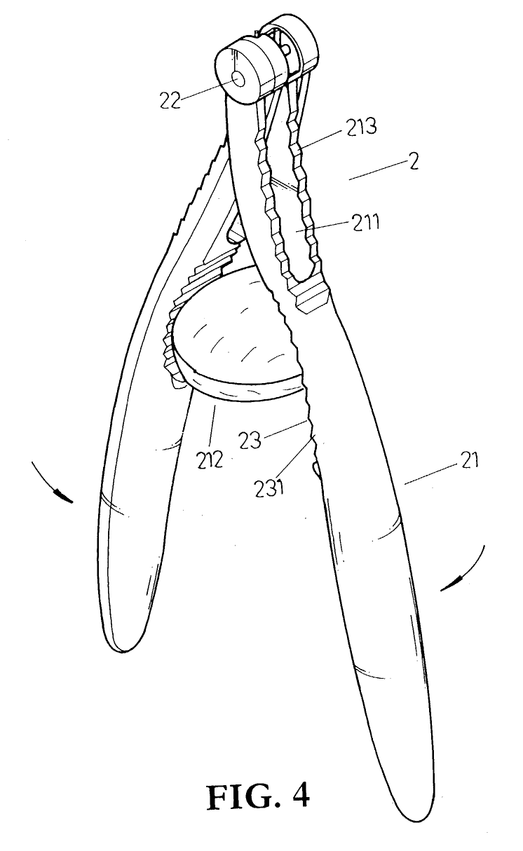

When the cracker is in a state shown in FIG. 2, a crushing space 212 is defined between the first working faces 211 of the handles 21. The cracker can be used to crush a crab claw, as shown in FIG. 3. The handles 21 of the cracker can be pivoted to a position shown in FIG. 4 for crushing a walnut that is held in a crushing space 212 defined between the second working faces 23. Thus, the cracker in accordance with the present invention can be used to crush at least two kinds of rigid-shelled food. The catching ribs 213 and the catching ribs 231 may be different in width, pitch, and alignment. Alternately, the catching ribs 213 and 231 can be arranged to crack rigid-shelled food other than walnuts and crab claws.

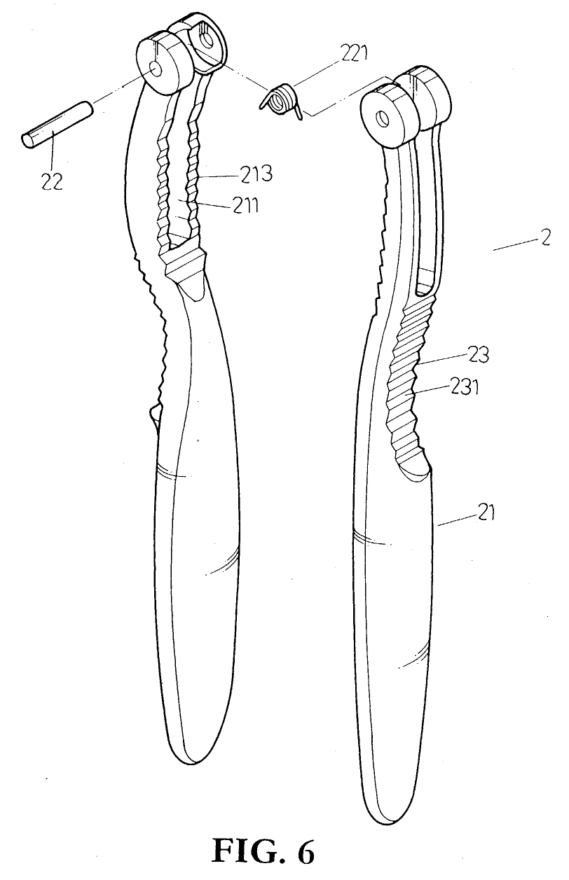

Referring to FIG. 6, a resilient member 221 is mounted around the pin 22 and includes two ends respectively attached to the pivoted ends of the handles 21. The resilient member 221 returns the handles 21 to their original positions after the force applied to the handles 21 is released.

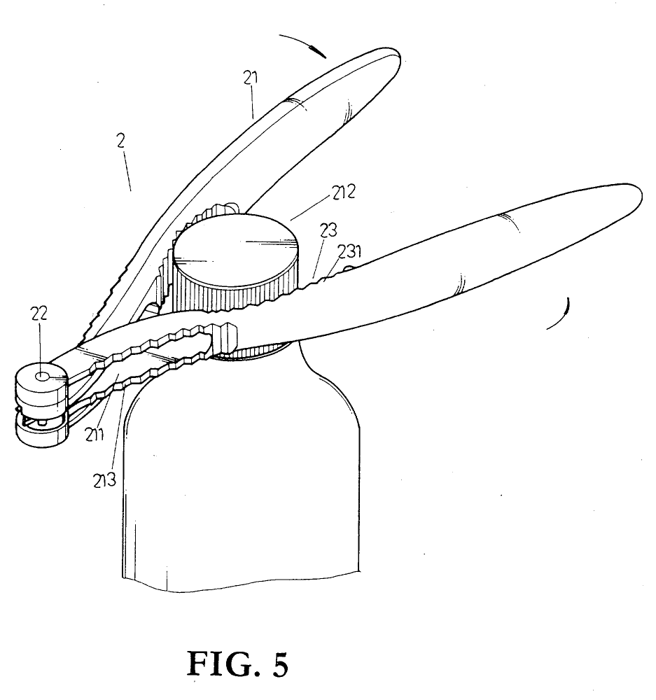

Referring to FIG. 5, the cracker in accordance with the present invention can also be used as a bottle opener to remove a cap from a bottle that is difficult to open.

According to the above description, it is appreciated that the cracker in accordance with the present invention comprises two sets of working faces on two opposite sides of the handles, thereby allowing crushing of rigid-shelled food of different kinds and sizes. The problems resulting from the use of conventional crackers are thus eliminated. The resilient member 221 returns the handles 21 to their original positions after the force applied to the handles 21 is released, which saves the force required to return the handles 21.

Although the invention has been explained in relation to its preferred embodiment, it is to be understood that many other possible modifications and variations can be made without departing from the scope of the invention as hereinafter claimed.

What is claimed is:

1. A cracker comprising:
a first handle including a first end and a second end, the first handle further including a first working face on a first side thereof and a second working face on a second side thereof that is opposite to the first side of the first handle;
a second handle including an end pivotally connected to the first end of the first handle, the second handle further including a first working face on a first side thereof and a second working face on a second side thereof that is opposite to the first side of the second handle;
the first working face of the first handle and the first working face of the second handle together defining a first crushing space when the first handle and the second handle are in a first relative position;
the second working face of the first handle and the second working face of the second handle together defining a second crushing space when the first handle and the second handle are in a second relative position.

2. The cracker as claimed in claim 1, wherein the first end of the first handle and the end of the second handle are pivoted together by a pin, further comprising a resilient member mounted around the pin and including a first end attached to the first end of the handle and a second end attached to the end of the second handle, the resilient member returning the first handle and the second handle to their original position when a force applied to the first handle and the second handle is released.

3. The cracker as claimed in claim 1, wherein the first working face of each of the first handle and the second handle comprises a plurality of catching ribs for catching a rigid-shelled food received in the first crushing space.

4. The cracker as claimed in claim 1, wherein the second working face of each of the first handle and the second handle comprises a plurality of catching ribs for catching a rigid-shelled food received in the second crushing space.

5. The cracker as claimed in claim 1, wherein the first crushing space is capable of receiving a rigid-shelled food of a first kind, the second crushing space being capable of receiving a rigid-shelled food of a second kind other than the rigid-shelled food of the first kind.

6. The cracker as claimed in claim 5, wherein the first end of the first handle and the end of the second handle are pivoted together by a pin, further comprising a resilient member mounted around the pin and including a first end attached to the first end of the handle and a second end attached to the end of the second handle, the resilient member returning the first handle and the second handle to their original position when a force applied to the first handle and the second handle is released.

7. The cracker as claimed in claim 5, wherein the first working face of each of the first handle and the second handle comprises a plurality of catching ribs for catching the rigid-shelled food of the first kind received in the first crushing space.

8. The cracker as claimed in claim 5, wherein the second working face of each of the first handle and the second handle comprises a plurality of catching ribs for catching the rigid-shelled food of the second kind received in the second crushing space.

9. The cracker as claimed in claim 7, wherein the second working face of each of the first handle and the second handle comprises a plurality of second catching ribs for catching the rigid-shelled food of the second kind received in the second crushing space.

10. The cracker as claimed in claim 1, wherein the first working face of the first handle is formed on a section of the first side of the first handle adjacent to the first end of the first handle, the first working face of the second handle being formed on a section of the first side of the second handle adjacent to the end of the second handle, the second working face of the first handle being formed on an intermediate section of the second side of the first handle, the second working face of the second handle being formed on an intermediate section of the second side of the second handle.

11. The cracker as claimed in claim 2, wherein the first working face of the first handle is formed on a section of the first side of the first handle adjacent to the first end of the first handle, the first working face of the second handle being formed on a section of the first side of the second handle adjacent to the end of the second handle, the second working face of the first handle being formed on an intermediate section of the second side of the first handle, the second working face of the second handle being formed on an intermediate section of the second side of the second handle.

12. The cracker as claimed in claim 6, wherein the first working face of the first handle is formed on a section of the first side of the first handle adjacent to the first end of the first handle, the first working face of the second handle being formed on a section of the first side of the second handle adjacent to the end of the second handle, the second working face of the first handle being formed on an intermediate section of the second side of the first handle, the second working face of the second handle being formed on an intermediate section of the second side of the second handle.

13. The cracker as claimed in claim 9, wherein the first working face of the first handle is formed on a section of the first side of the first handle adjacent to the first end of the first handle, the first working face of the second handle being formed on a section of the first side of the second handle adjacent to the end of the second handle, the second working face of the first handle being formed on an intermediate section of the second side of the first handle, the second working face of the second handle being formed on an intermediate section of the second side of the second handle.
